(19) United States
(12) Patent Application Publication
(10) Pub. No.: US 2019/0314860 A1
(43) Pub. Date: Oct. 17, 2019

(54) LINEAR VIBRATION MOTOR

(71) Applicant: NIDEC COPAL CORPORATION, Tokyo (JP)

(72) Inventor: Yoshinori KATADA, Tokyo (JP)

(73) Assignee: NIDEC COPAL CORPORATION, Tokyo (JP)

(21) Appl. No.: 16/343,121

(22) PCT Filed: Oct. 10, 2017
(86) PCT No.: PCT/JP2017/036696

§ 371 Date: Apr. 18, 2019

(30) Foreign Application Priority Data
Oct. 31, 2016 (JP) 2016-212971

(51) Int. Cl. B06B 1/04; H02K 33/12; H02K 33/16; H02K 33/02; H02P 25/032

(52) U.S. Cl. CPC B06B 1/045; H02K 33/12; H02P 25/032; H02K 33/02; H02K 33/16

(57) ABSTRACT

Provided is a linear vibration motor having a structure requiring less space and also having good responsiveness. This linear vibration motor is characterized by having a mover having weights affixed on the longitudinal end side of a pair of long magnets; a coil provided in a long shape in the longitudinal direction of the pair of magnets and driving and reciprocating the mover in the transverse direction by a magnetic action produced by the conduction of electricity; a base to which the coil is affixed; and an elastic member elastically deformed by the reciprocation of the mover.

### CROSS-REFERENCE TO RELATED APPLICATIONS

This application is a National Stage of International Application PCT/JP2017/036696 filed Oct. 10, 2017, which claims priority to Japanese Application No. 2016-212971 filed Oct. 31, 2016. The above applications are incorporated herein by reference in their entirety.

### FIELD OF TECHNOLOGY

The present invention relates to a linear vibration motor.

### BACKGROUND

Vibration motors (or “vibration actuators”) are built into mobile electronic devices, and are broadly used as devices to communicate to the user, through a vibration, that there is an incoming call, or that a signal, such as an alarm, or the like, has been generated, and have become indispensable devices in wearable devices, which are carried on the body of the user. Moreover, in recent years vibration motors have been of interest as devices by which to achieve haptics (skin-sensed feedback) in the human interfaces such as touch panels.

Among the various forms of vibration motors of this type that are under development, there is interest in linear vibration motors that are able to generate relatively large vibrations through linear reciprocating vibrations of a movable element. Such linear vibration motors are provided with a weight and a magnet on a movable element side, where an electric current is applied to a coil that is provided on the stator side to cause the Lorentz forces that act on the magnet to form a driving force, to cause the movable element, which is elastically supported along the direction of vibration, to undergo reciprocating vibrations in the axial direction (referencing, for example, Japanese Unexamined Patent Application Publication 2016-131915).

However, in the conventional technology shown in the Japanese Unexamined Patent Application Publication 2016-13191, the linear vibration motor as a whole is configured in a long shape along the direction of vibration, and because a coil and a pair of magnets are arranged toward the center, in the lengthwise direction, the area over which the pair of magnets receives the magnetism, for reciprocating driving, from the coil is remarkably small when compared to the overall area of the linear vibration motor. In this conventional structure, in order to increase the vibration amplitude and in order to improve the startup performance, one may consider providing a separate circuit for amplifying the supplied electric power, or providing a plurality of pairs of magnets and coils in a line, but there is the danger that this will lead to increased cost and increased size.

In particular, with, for example, a touch panel that has a touch operation vibration function for producing a vibration in response to a touch operation, good responsiveness is required, in addition to a space-saving structure.

### SUMMARY

In order to solve such a problem, the present invention is provided with the following structures:

A linear vibration motor having a movable element for securing a weight body to a lengthwise-direction end portion side of a pair of long magnets; a coil, provided in a long shape along the lengthwise direction of the pair of magnets, for reciprocatingly driving the movable element, in the short direction, through magnetism when power is supplied; a substrate whereon the coil is secured; and an elastic member that undergoes elastic deformation through the reciprocating motion of the movable element.

### BRIEF DESCRIPTIONS OF THE DRAWINGS

FIG. 1 is an exploded perspective diagram illustrating an example of a linear vibration motor according to the present invention.

FIG. 2 is a plan view of the same linear vibration motor, where the cover portion is shown by the double dotted line.

FIG. 3 is a cross-sectional diagram wherein the linear vibration motor is cut at the center in the short direction.

FIG. 4 is a cross-sectional drawing wherein the linear vibration motor is cut at the center in the direction of thickness.

FIG. 5 is a perspective diagram showing an example of a yoke from the magnet attaching surface side.

FIG. 6 is a cross-sectional diagram wherein another example of a linear vibration motor according to the present invention is cut at the center in the short direction.

FIG. 7 is a perspective diagram depicting an example of a mobile electronic device equipped with a linear vibration motor.

### DETAILED DESCRIPTION

Embodiments according to the present invention will be explained below in reference to the drawings. In the descriptions below, identical reference symbols in the different drawings below indicate positions with identical functions, and redundant explanations in the various drawings are omitted as appropriate.

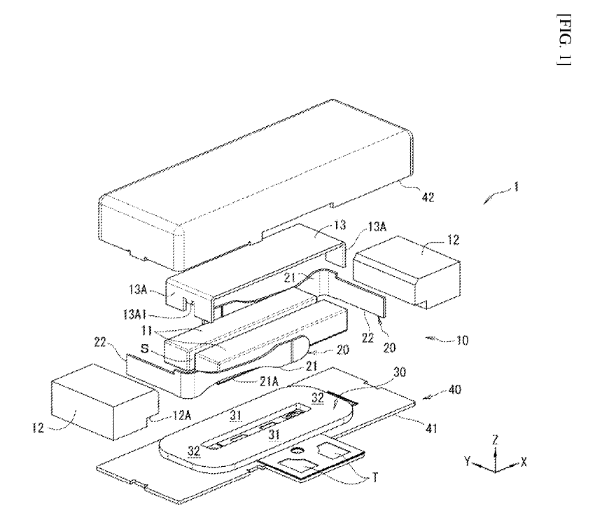

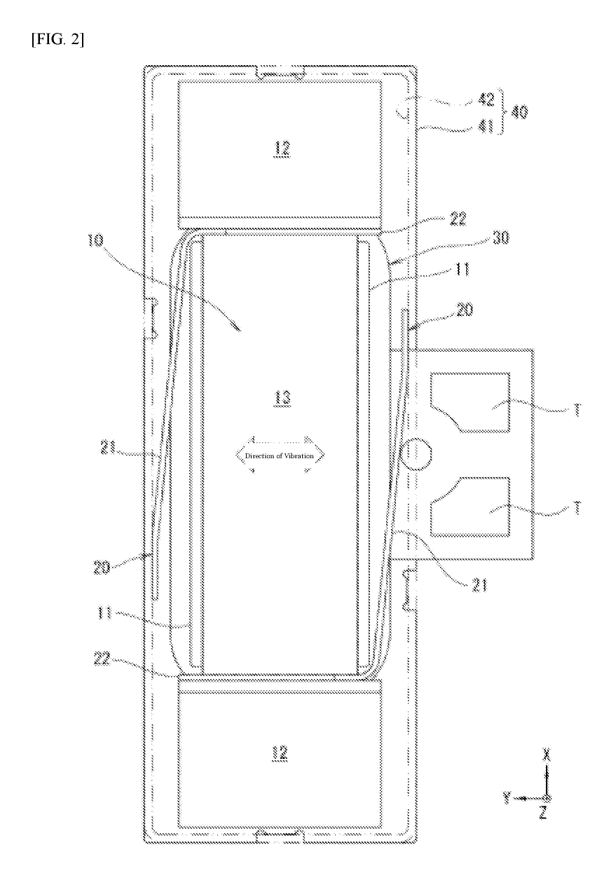

A linear vibration motor 1 includes a long movable element 10; elastic members 20 and 20 for supporting the movable element 10 so as to elastically repel it in the short direction (the Y direction in the example in the figure), which is perpendicular to the lengthwise direction (the X correction in the example in the figure); a coil 30 for driving the movable element 10 reciprocatingly in the short direction through magnetism when power is applied; and a substrate 40, on which the coil 30 is secured (referencing FIG. 1 through FIG. 5).

The movable element 10 includes a pair of long magnets 11 and 11; weight bodies 12 and 12 that are secured on both end sides, in the lengthwise direction, of these magnets 11 and 11; and a yoke 13 that is secured across the pair of magnets 11 and 11, in the lengthwise direction, on the side that is opposite from the coil side, and that is supported, by elastic members 20 and 20, so as to vibrate in the short direction.

Each magnet 11 is formed in a long rectangular box shape, with one direction that is perpendicular to the face of the coil 30 (the Z direction in the drawings) as the north pole, and the other direction as the south pole.

The pair of magnets 11 and 11 is provided essentially in parallel, with a space S therebetween. One of the magnets 11 has the magnetic pole reversed in respect to that of the other magnet 11.

This pair of magnets 11 and 11 is secured as a single unit through a yoke 13.

The yoke 13 is formed in a long shape covering the face of the pair of magnets 11 and 11 on the side opposite from the coil, and has a protruding piece portions 13A and 13A that protrude to the coil 30 side, on both end sides thereof in the lengthwise direction. This yoke 13 is formed in a shape that is essentially box-like, in the cross-section, through bending machining of essentially rectangular plate material, made from a magnetic material, for example.

Each protruding piece portion 13A is bonded, through an adhesive agent, to an end portion of the pair of magnets 11 and 11. The protruding piece portion 13A has a fitting piece portion 13A1 toward the center in the width direction (the Y direction in the figure).

The fitting piece portion 13A1 fits together by being placed between the pair of magnets 11 and 11, producing a uniform spacing between the pair of magnets 11 and 11.

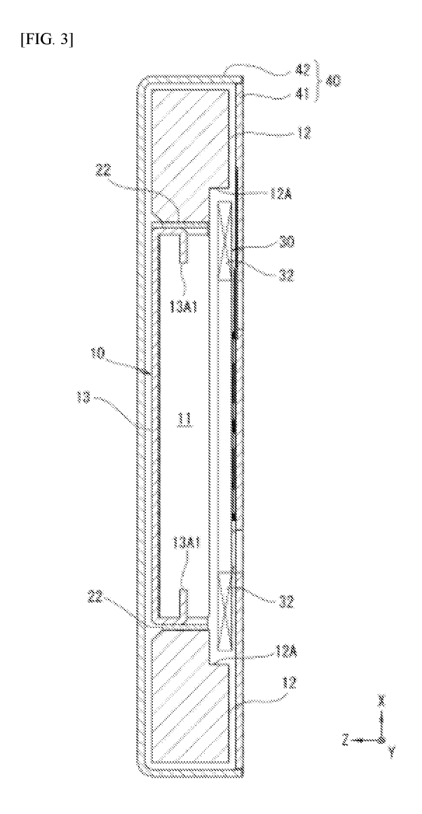

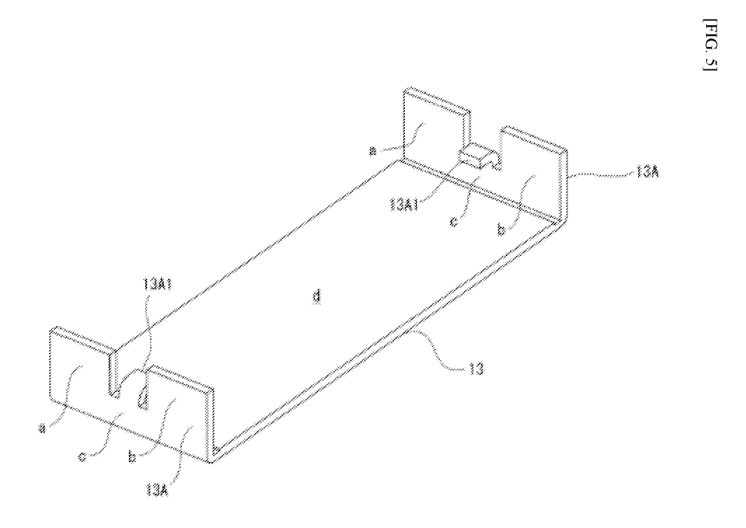

In a preferred embodiment depicted in FIG. 3, this fitting piece portion 13A1 is located toward the center of the magnet 11 in the thickness direction (the Z direction in the figure). Given this placement, as illustrated in FIG. 5, in the protruding piece portion 13A, the two side parts a and b, between which the fitting piece portion 13A1 is placed, are joined together by a base side part c of the fitting piece portion 13A1, and thus the degree of parallel of the two side parts a and b, and the degree of perpendicular in relation to the main body face d, can be held with high precision.

The elastic member 20 is formed through bending a long plate material made from an elastic bendable metal. In the example in the figure, it is formed in essentially a L shape. Explaining in more detail, this elastic member 20 comprises: one piece portion 21 along the end face, in the short direction, of the pair of magnet 11 and 11, and an other piece portion 22 that is essentially perpendicular to the one piece portion 21. The end face 11B of the magnet 11, in the short direction, and the side wall of the substrate 40 (the cover portion 42) face each other directly, and the one piece portion 21 extends therebetween. This one piece portion 21 is supported on the substrate 40, which is a stationary position.

Moreover, the other piece portion 22 is secured held between one of the magnets 11 (specifically, the outer surface of the protruding piece portion 13A) and a weight body 12. Welding, for example, may be used as the means for securing. That is, the other piece portion 22 of the elastic member 20 is secured through welding to the protruding piece portion 13A of the yoke 13, and the weight body 12 is secured through welding to the other piece portion 22.

This securing portion enables prevention of damage to the connecting part between the elastic member 20 and the movable element 10 due to vibrations, or the like.

A thin portion 21A, wherein the dimension in the thickness direction of the movable element 10 is reduced, is provided toward the center, in the lengthwise direction, of the one piece portion 21 of the elastic member 20. This thin portion 21A disperses the stresses that act on the connecting part between the one piece portion 21 and the substrate 40, or on the bend part between the one piece portion 21 and the other piece portion 22, or the like, due to vibration of the movable element 10.

The weight bodies 12 and 12 on both sides in the lengthwise direction may be structured through, for example, a metal material with a relatively high specific gravity (such as tungsten), and, in the example that is illustrated, is formed in a square shape that has a Z-direction height that is greater than the thickness of a pair of magnets 11 and 11, and a width in the Y direction that is greater than the width of the pair of magnets 11 and 11.

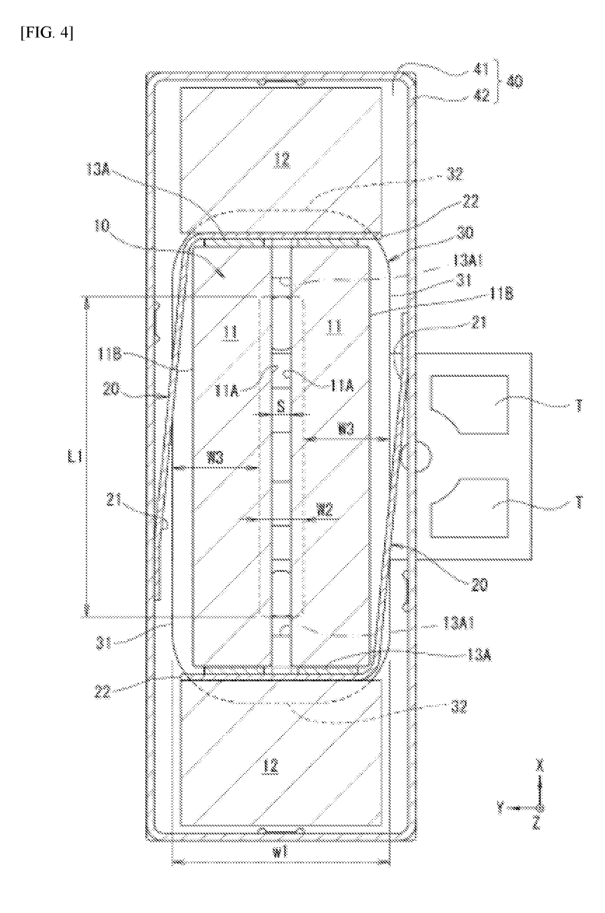

Each weight body 12 is located so as to not overlap, in the plan view, a straight part 31 of the coil 30. That is, each weight body 12 is provided with one end side, in the lengthwise direction of the movable element 10, overlapping the connecting part 32 of the coil 30, and the other end side extending to the outside of the coil 30 (referencing FIG. 4).

Moreover, a notch portion 12A, passing through in the direction of vibration of the movable element 10 (the Y direction), is provided in a corner part of each weight body 12 on the coil 30 side (referencing FIG. 1 and FIG. 3).

This notch portion 12A is formed so as to provide a prescribed gap, relative to the end face and surface on the end portion side in the lengthwise direction of the coil 30. That is, in the weight body 12, as illustrated in FIG. 3, the notch portion 12A is provided in essentially an inverted L shape, in the cross-section, adjacent to the end face in the Z direction and the end face in the X direction, of the connecting part 32. This structure enables efficient use of the limited space within the substrate 40, to position the weight bodies 12 so as to not interfere with the reciprocating motion of the movable element 10.

The coil 30 is a hollow core coil that is not provided with a core material, coiled in a long flat shape, provided essentially in parallel, with a gap therebetween, in respect to the faces of the pair of magnets 11 and 11, on the side opposite from the yoke 13. This coil 30 has two straight parts 31 and 31, that extend in the lengthwise direction of the pair of magnets 11 and 11, and connecting parts 32 and 32 that connect the respective end sides of the straight parts 31 and 31.

Each straight part 31 is a part that extends essentially in a straight line along the lengthwise direction of the pair of magnets 11 and 11. The dimension L1 of the straight part 31 in the lengthwise direction is essentially identical to the dimension, in the lengthwise direction, of the hollow portion in the center of the coil 30.

The two straight parts 31 and 31 are positioned along the respective magnets 11 and 11 of the pair thereof. The dimension L1 of each straight part 31 is set so as to be slightly shorter than the total length of the magnet 11. Additionally, each magnet 11 is provided so as to bridge, in the lengthwise direction, each of the straight parts 31, in the plan view. That is, the end portion, in the lengthwise direction, of each magnet 11 is positioned within the connecting part 32 of the coil 30 (referencing FIG. 4).

Given this placement, the magnetic field produced in the straight part 31 when power is applied can act effectively on each of the magnet portions, making it resistant to adverse effects of dimensional tolerance in the lengthwise direction.

In the short direction (the X direction) that is perpendicular to the lengthwise direction, the width W1 of the coil 30 is set so as to be broader than the width, in the same direction, of the pair of magnets 11 and 11, where the end faces 11B and 11B, in the short direction, of the pair of magnets 11 and 11 are each positioned within a width W3 of the facing straight parts 31.

Given this, the width W2, between the two straight parts 31 and 31, is set so as to be larger than the space S between the pair of magnets 11 and 11, where the inner edge portions 11A and 11A, between the pair of magnets 11 and 11, are positioned within the width W2.

This arrangement enables a stabilized driving force by maintaining, essentially constant, the area of overlap between the coil 30 and the pair of magnets 11 and 11, in the plan view, even when, in the linear vibration motor 1, the movable element 10 is moved in the short direction through the application of power.

Moreover, the substrate 40 comprises a substrate portion 41 that supports and secures the coil 30, and a cover portion 42 that surrounds the movable element 10 and covers the side opposite of the coil, and is structured in a long shape along the coil 30 and the movable element 10.

The substrate portion 41 is formed in essentially a long rectangular plate-shaped, with terminals T and T protruding from the long edge part thereof. The terminals T and T are connected respectively to the two end portions of the coil 30, to supply a driving signal made from an AC current or a pulsed current that has the resonant frequency (natural frequency) determined by, for example, the mass of the movable element 10 and the coefficient of elasticity of the elastic members 20.

The cover portion 42 is formed in essentially a rectangular box-shape, open on the substrate portion 41 side, and is connected to the peripheral edge side of the substrate portion 41.

In this cover portion 42, the tip end sides of the respective one piece portions 21 of the elastic members 20 are welded to the side wall inner surfaces of the two ends, in the short direction.

The distinctive effects of operation will be explained next for the linear vibration motor 1 that is structured as described above.

When AC electric power is supplied to the coil 30, the movable element 10 is caused to undergo reciprocating motion, in the short direction, through the magnetism between the magnets 11 and 11 and the coil 30, which structure a magnetic circuit wherein the magnetic flux is perpendicular to the straight parts 31 of the coil 30, and accompanying this reciprocating motion, the elastic members 20 and 20 undergo elastic deformation, and the vibration through this reciprocating motion is transmitted to the substrate 40.

In the linear vibration motor 1 of the present embodiment, a pair of magnets 11 and 11 is provided along the lengthwise direction of the long coil 30, where weight bodies 12 and 12 are secured to both end portions of the pair of magnets 11 and 11, and thus when compared, for example, to a structure wherein a plurality of coils and pairs of movable elements are assembled in a long shape and the movable elements are caused to undergo reciprocating motion in the direction wherein they are lined up, the pair of magnets 11 and 11 can secure a broader effective area for receiving, from the coil 30, the magnetism for reciprocating driving (in other words, a broader area of overlap, in the plan view, between the pair of magnets 11 and 11 and the coil 30).

Thus this enables an improvement in the magnetic characteristics between the coil 30 and the pair of magnets 11 and 11, and of the startup performance, enabling an improvement in responsiveness when power is applied.

Furthermore, while the connecting parts 32 of the coil 30 do not contribute to driving the movable element 10 in the short direction, the weight bodies 12 are disposed so as to overlap a portion of these connecting parts 32, and thus, when compared to a structure wherein the weight bodies are provided on both end portions in the short direction, for example, the overall area in the plan view is reduced, enabling miniaturization of the linear vibration motor 1 as a whole.

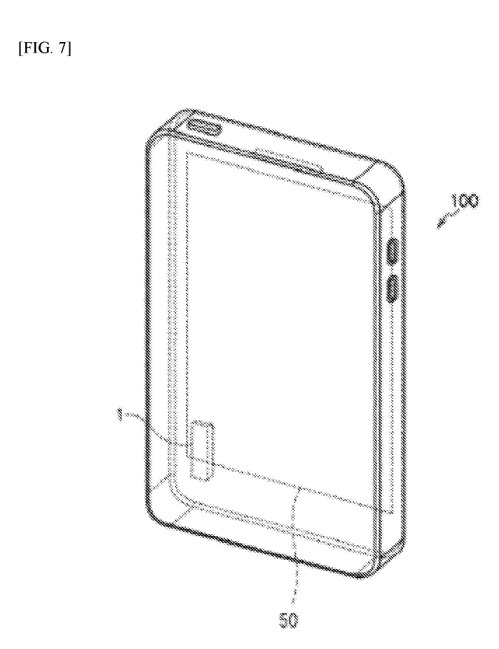

Moreover, FIG. 7 depicts an example of a touch operating panel 50 (touch input device) that is equipped with the linear vibration motor 1 of an embodiment according to the present invention, and a mobile information terminal 100, as an electronic device that is equipped with this touch operating panel 50.

The mobile information terminal 100 is structured so as to cause the linear vibration motor 1 to vibrate in response to a touch operation on the touch operating panel 50 (including a touch display), and the responsiveness thereof is good. Moreover, through the linear vibration motor 1 being thinner and smaller, a mobile information terminal 100 can be produced that has high portability and good design performance. Moreover, the linear vibration motor 1 is of a compact shape wherein the various portions are contained within a substrate 40 of a box shape, of limited height, enabling equipping, with good spatial efficiency, within a thin mobile information terminal 100.

Note that, as another example, the linear vibration motor 1 may be equipped in an electronic device that is not equipped with a touch operating panel 50.

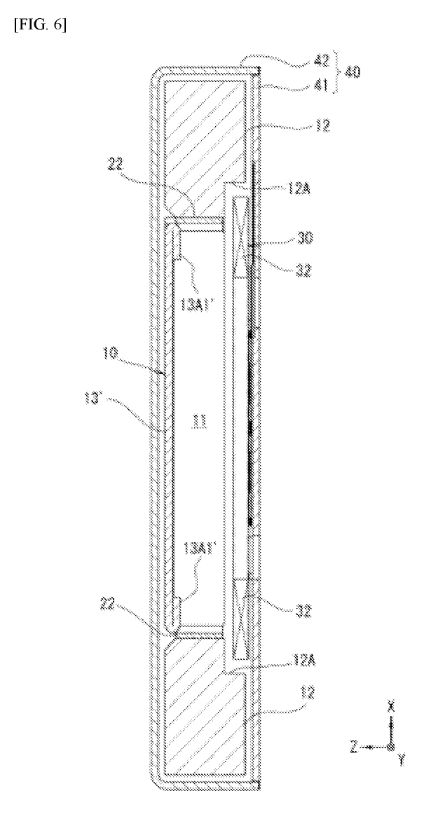

Moreover, given the embodiments described above, a configuration wherein the fitting piece portion 13A1 of the yoke 13 is placed toward the center, in the thickness direction (the Z direction in the figure) was illustrated as a particularly preferred form, but, as another example, as illustrated in FIG. 6, the configuration may be one having a fitting piece portion 13A1′ of a shape that is folded back.

In the linear vibration motor 2, depicted in FIG. 6, the yoke 13 in the linear vibration motor 1, described above, has been replaced with a yoke 13′, where the yoke 13′ has a fitting piece portion 13A1′ instead of the fitting piece portion 13A1 that is described above.

The magnetic characteristics and startup performance are improved through this linear vibration motor 2 as well, enabling improved responsiveness.

Moreover, while in the embodiments described above, the movable element 10 is supported by elastic members 20 of a leaf spring type, as another example, a form is possible wherein the movable element 10 is supported by an elastic member (not shown), such as a coil spring or elastic synthetic resin, a form is possible wherein a shaft is provided separately for supporting the movable element 10 so as to move on a straight line, and so forth.

While embodiments according to the present invention were described in detail above, referencing the drawings, the specific structures thereof are not limited to these embodiments, but rather design variations within a range that does not deviate from the spirit and intent of the present invention are also included in the present invention. Moreover, insofar as there are no particular contradictions or problems in purposes or structures, or the like, the technologies of the various embodiments described above may be used together in combination.

What is claimed is:

1. A linear vibration motor comprising:
a movable element securing a weight body to a lengthwise-direction end portion side of a pair of long magnets;
a coil, provided in a long shape along the lengthwise direction of the pair of magnets, reciprocatingly driving the movable element, in the short direction, through magnetism when power is supplied;
a substrate whereon the coil is secured; and
an elastic member that undergoes elastic deformation through the reciprocating motion of the movable element.

2. The linear vibration motor as set forth in claim 1, wherein:
the coil comprises two straight parts along the lengthwise direction, and connecting parts connecting both end sides of the straight parts; and
the pair of magnets is provided along the two straight parts, respectively, where each magnet is positioned bridging the individual straight parts, in the lengthwise direction in the plan view.

3. The linear vibration motor as set forth in claim 2, wherein:
the weight body is disposed so as to not overlap the straight part in the plan view.

4. The linear vibration motor as set forth in claim 1, wherein:
the elastic member comprises one piece portion along the end face, in the short direction, of the magnet, and another piece portion that is perpendicular to the one piece portion, wherein the one piece portion is supported in a stationary position, and the other piece portion is secured held between the magnet and the weight body.

5. The linear vibration motor as set forth in claim 4, wherein:
a yoke is secured, along the lengthwise direction, on the side of the magnets that is opposite from the coil side; and
the yoke comprises a piece portion, along the lengthwise direction end face of the magnet, are an end portion side in the lengthwise direction, where the other piece portion of the elastic member is held between the protruding piece portion and the weight body.

6. The linear vibration motor as set forth in claim 5, wherein:
the pair of magnets comprises a space in the short direction; and
a fitting portion fitting into the space of the pair of magnets is provided on the yoke.

7. The linear vibration motor as set forth in claim 1, wherein:
the substrate is provided in a long shape along the lengthwise direction of the coil.

8. A touch input device comprising a linear vibration motor as set forth in claim 1.

9. An electronic device comprising a linear vibration motor as set forth in claim 1.
